(19) United States
(12) Patent Application Publication
(10) Pub. No.: US 2026/0307376 A1
(43) Pub. Date: Oct. 8, 2026

(54) A METHOD FOR PRODUCING A FULLY BONDED WATERBAR

(71) Applicant: SIKA TECHNOLOGY AG, Baar (CH)

(72) Inventors: Roman DA RIN, Emmenbrücke (CH); Yang Soo LEE, Anyang-si (KR); Hans SCHMIDHOFER, Lofer (AT); Simon SCHOENBRODT, Sarnen (CH); Isabel Andrea SIEGRIST, Sachseln (CH)

(73) Assignee: SIKA TECHNOLOGY AG, Baar (CH)

(21) Appl. No.: 19/482,901

(22) PCT Filed: Jul. 29, 2024
(86) PCT No.: PCT/EP2024/071400

§ 371 Date: Nov. 10, 2025

(30) Foreign Application Priority Data
Jul. 28, 2023 (EP) 23188516.1

(51) Int. Cl. B32B 27/30; B32B 27/08; B32B 37/24; B32B 38/00; E04B 1/68

(52) U.S. Cl. CPC B32B 27/306; B32B 27/08; B32B 37/24; E04B 1/6807; B32B 2037/243; B32B 2038/0084; B32B 2419/00

(57) ABSTRACT

A method for producing a waterbar, the method including steps of providing first and second sealing elements each including a carrier layer having upper and lower major surfaces and a filled polymeric layer covering at least a portion of the upper major surface of the carrier layer and bonding the lower major surface of the carrier layer of the first sealing element to at least a portion of the lower major surface of the carrier layer of the second sealing element.

### TECHNICAL FIELD

The invention relates to sealing elements and use thereof for sealing of concrete joints against penetration of water. Particularly, the present invention relates to a method for producing of waterbars, which are suitable for sealing of joints formed between casted sections of concrete.

### BACKGROUND ART

Polymeric sheets, which are often referred to as waterproofing membranes, are commonly used in the construction industry for sealing of bases, underground surfaces or buildings against water penetration. Waterproofing membranes are applied, for example, to prevent ingress of water through cracks that develop in the concrete structure due to building settlement, load deflection or concrete shrinkage. Furthermore, large concrete structures, such as slabs, dams, tanks, and foundations, cannot be casted as one monolithic unit and, therefore, they contain a number of joints formed between the concrete bodies. These concrete joints also must be sealed to prevent passage of water into and through the joint.

Waterproof profiles, also known as waterbars or waterstops, are commonly used for sealing of concrete joints. They are provided in a range of different compositions, shapes and sizes to suit different types of concrete structures and sealing applications. Joints typically are provided between adjacent concrete bodies to accommodate expected physical changes of concrete when subjected to environmental and mechanical conditions or to assist in the construction and placement of concrete. Physical changes may result from drying, shrinkage, carbonation, or creep of the concrete mass or from a load applied on the concrete body. A joint can also be formed between concrete bodies, for example, due to a scheduled or unscheduled interruption in concrete placement.

Expansion joints are formed in concrete structures at regular intervals to accommodate the movement caused by expansion of concrete mass. Expansion joints are also commonly designed to isolate structural elements from each other, such as walls or columns from floors and roofs, pavement from bride decks, or where wall elements change directions.

Contraction joints are used to regulate the cracking that occurs due to unavoidable and unpredictable contraction during hardening of concrete. Contraction joints may be made during casting of the concrete by forming the joint with a plate or after construction by cutting the joint. Furthermore, construction joints are created at certain locations during massive concrete placements due to scheduled or unscheduled interruptions. In these cases, the casted concrete bodies are not expected to have dimensional changes and, therefore, construction joints are not provided with a predetermined expansion gap.

Waterbars are typically provided as strip-like profiles having a center portion and two side portions or side flanges located on opposite sides of the center portion. Depending on the application, the center portion of a waterbar can be positioned along a concrete joint (“external waterbar”) or inside the concrete joint to be formed (“internal waterbar”).

Waterbars are provided in various shapes and sizes to fulfill the requirements of the relevant sealing application. Flat and dumbbell-shaped waterbars are typically used for sealing of construction and contraction joints whereas waterbars with an expansion element, such as a “centerbulb”, are mainly used for sealing of expansion joints. The centerbulb is typically provided as a hollow profile, which allows wider range of movement in transverse, lateral, or shear directions without excessively stretching the material.

Waterbars are typically used in pre-applied waterproofing applications, where the sealing element is installed in place prior to the concrete joint to be waterproofed has been formed. A waterbar can installed as an external sealing element, in which case the side flanges of the waterbar are embedded in the rear face of a concrete structure or as an internal sealing element, in which case the side flanges become completely embedded in the casted concrete structure. The method for sealing a concrete joint using an external waterbar typically comprises steps of placing the waterbar on a base and casting the sections of concrete such that the side flanges become embedded in rear faces of the casted concrete bodies and the center portion of the waterbar is located along the formed concrete joint. External waterstops are equally suitable for sealing of expansion, construction, and contraction joints.

The method for sealing a concrete joint using an internal waterbar typically comprises steps of placing the waterbar inside the joint to be formed after casting of concrete such that the center portion is positioned in the middle of the planned concrete joint. The Installation of the waterstop can be conducted, for example, by using a split formwork, which allows the insertion of the waterstop through the formwork. Typically, at least one of the side flanges is fixed to reinforcing steel bars in order to prevent undesired movement of the waterstop during casting of the concrete sections. After the first section of concrete has been casted, the formwork is removed followed by casting of the second section of concrete. In case an expansion joint, an expansion or a filler board is typically positioned in the joint opening after the formwork has been removed and before casting of the second section of concrete. Such expansion boards are composed of compressible materials, such as foam-and fiber-based materials and they are designed to absorb the expansion and contraction movements of the adjacent concrete bodies.

Most commonly used materials for providing waterstops include metals and polymers, such as rubbers, for example styrene-butadiene rubber, butyl rubber, nitrile rubber, and ethylene propylene diene monomer (EPDM) rubber, and thermoplastics, in particular polyolefins and polyvinylchloride (PVC). The polymers do not bond well to concrete and, therefore, the side flanges of a waterbars are typically provided with multiple raised ribs, fins, or other protrusions, which provide mechanical interlocking to the concrete structures and a seal against flow of water when embedded in the concrete structure. Strip-like thermoplastic profiles can be easily produced by extrusion techniques but the variety of the shapes of the laterally extending flanges complicates the production process and increases the production costs. Furthermore, waterbars are typically composed of relatively stiff materials to enable effective anchoring of the side flanges to casted concrete structures via fins, ribs and other protrusions. Due to the stiffness of the material and the presence of the protrusions, waterbars cannot be stored in form of rolls like waterproofing membranes, which increases the amount of space required for transportation and storage of the waterbars.

Published patent application EP 3645804 A1 discloses a multi-layer fully bonded waterbar comprising a profile with a center portion and two side portions, wherein at least one of the top and bottom surfaces of the side portions is at least partially covered with a functional coating, which is operative to bond with a fresh cementitious composition. The advantage of the disclosed waterbar design is that the side portions can be anchored to the concrete structures without the use of ribs or other keying formations, which decreases the production costs of the waterbar. However, the method for producing the disclosed waterbar is still complicated by the fact that the multi-layer structure with a profile and two functional coatings is produced by co-extrusion process requiring the use of three individual extruders.

There is thus a need for a novel method for producing a fully bonded waterbar, which method solves or at least mitigates the problems of the prior art methods as discussed above.

### SUMMARY OF THE INVENTION

The objective of the present invention is to provide method for producing a fully bonded waterbar, which method solves or at least mitigates the problems of the prior art methods as discussed above.

Particularly, it is an object of the present invention to provide a simplified method that enables production of fully bonded waterbars with reduced costs compared to the methods of prior art.

Surprisingly it has been found out that the objects can be achieved with the features of claim 1.

Specifically, according to the invention, a method for producing a waterbar (1) is proposed, the method comprising steps of:
I) Providing first and second sealing elements (2, 3) each comprising a carrier layer (4, 4′) comprising at least one polymer P1 and having upper and lower major surfaces and a functional layer (5, 5′) covering at least a portion of the upper major surface of the carrier layer (4, 4′) and
II) Bonding the first and second sealing element (2, 3) to each other such that their carrier layers (4, 4′) become directly or indirectly connected to each other over at least parts of their opposing lower major surfaces,
wherein the functional layer (5, 5′) of the first and second sealing elements (2, 3) is operative to bond with a fresh cementitious composition casted against it and allowed to harden.

As it turned out, the suggested method enables producing fully bonded waterbars with reduced costs compared to the methods disclosed in prior art.

Additional aspects of the present invention are presented in further independent claims. Preferred embodiments of the invention are outlined throughout the description and the dependent claims.

### BRIEF DESCRIPTION OF THE DRAWINGS

FIG. 1 shows a cross-section of a sealing element (2) comprising a carrier layer (4) having upper and lower major surfaces and a functional layer (5) covering substantially the whole area of the upper major surface of the carrier layer (4).

FIG. 2 shows a cross-section of a sealing element (2) comprising a carrier layer (4) having upper and lower major surfaces, a functional layer (5) covering substantially the whole area of the upper major surface of the carrier layer (4), and a reinforcement layer (7) fully embedded into the carrier layer (4).

FIG. 3 shows a cross-section of a sealing element (2) comprising a carrier layer (4) having upper and lower major surfaces, a functional layer (5) covering substantially the whole area of the upper major surface of the carrier layer (4), and a reinforcement layer (7) arranged between the carrier layer (4) and the functional layer (5).

FIG. 4 shows a cross-section of a sealing element (2) comprising a carrier layer (4) having upper and lower major surfaces and a functional layer (5) covering substantially the whole area of the upper major surface of the carrier layer (4), wherein the functional layer has an upper major surface containing a surface structure (6).

FIG. 5 shows a cross-section of a waterbar (1) comprising a first sealing element (2) and a second sealing element (3), wherein the carrier layers (4, 4′) of the sealing elements (2, 3) are directly connected to each other over their opposing lower major surfaces.

FIG. 6 shows a cross-section of a waterbar (1) comprising a first sealing element (2) and a second sealing element (3) and a reinforcing layer (8) sandwiched between the carrier layers (4, 4′) of the sealing elements (2, 3).

### DETAILED DESCRIPTION OF THE INVENTION

The subject of the present invention is a method for producing a waterbar (1) comprising steps of:
I) Providing first and second sealing elements (2, 3) each comprising a carrier layer (4, 4′) comprising at least one polymer P1 and having upper and lower major surfaces and a functional layer (5, 5′) covering at least a portion of the upper major surface of the carrier layer (4, 4′) and
II) Bonding the first and second sealing element (2, 3) to each other such that their carrier layers (4, 4′) become directly or indirectly connected to each other over at least parts of their opposing lower major surfaces,
wherein the functional layer (5, 5′) of the first and second sealing elements (2, 3) is operative to bond with a fresh cementitious composition casted against it and allowed to harden.

The term “polymer” designates a collective of chemically uniform macromolecules produced by a polyreaction (polymerization, polyaddition, polycondensation) where the macromolecules differ with respect to their degree of polymerization, molecular weight and chain length. The term also comprises derivatives of said collective of macromolecules resulting from polyreactions, that is, compounds which are obtained by reactions such as, for example, additions or substitutions, of functional groups in predetermined macromolecules and which may be chemically uniform or chemically non-uniform.

Term “polyolefin” refers to homopolymers and copolymers produced solely from olefin monomers. Accordingly, copolymers of olefin monomers and non-olefinic monomers, such as copolymers of ethylene and vinyl acetate, are not “polyolefins” according to the definition of the present invention.

The term “α-olefin” designates an alkene having the molecular formula CₓH₂ₓ (x corresponds to the number of carbon atoms), which features a carbon-carbon double bond at the first carbon atom (α-carbon). Examples of α-olefins include ethylene, propylene, 1-butene, 2-methyl-1-propene (isobutylene), 1-pentene, 1-hexene, 1-heptene and 1-octene. For example, neither 1,3-butadiene, nor 2-butene, nor styrene are referred as “α-olefins” according to the present document.

The term “rubber” designates a polymer or a polymer blend, which is capable of recovering from large deformations, and which can be, or already is, modified to a state in which it is essentially insoluble (but can swell) in a boiling solvent, in particular xylene. Typical rubbers are capable of being elongated or deformed to at least 200% of their original dimension under an externally applied force, and will substantially resume the original dimensions, sustaining only small permanent set (typically no more than about 20%), after the external force is released. As used herein, the term “rubber” may be used interchangeably with the term “elastomer.”

The term “softening point” designates a temperature at which compound softens in a rubber-like state, or a temperature at which the crystalline portion within the compound melts. The softening point can be determined by ring and ball measurement conducted according to DIN EN 1238:2011 standard.

The term “melting temperature” designates a temperature at which a material undergoes transition from the solid to the liquid state. The melting temperature (Tm) is preferably determined by differential scanning calorimetry (DSC) according to ISO 11357-3:2018 standard using a heating rate of 2° C./min. The measurements can be performed with a Mettler Toledo DSC 3+ device and the Tₘ values can be determined from the measured DSC-curve with the help of the DSC-software. In case the measured DSC-curve shows several peak temperatures, the first peak temperature coming from the lower temperature side in the thermogram is taken as the melting temperature (Tₘ).

The term “glass transition temperature” (T_{g}) designates the temperature above which temperature a polymer component becomes soft and pliable, and below which it becomes hard and glassy. The glass transition temperature is preferably determined by dynamical mechanical analysis (DMA) as the peak of the measured loss modulus (G″) curve using an applied frequency of 1 Hz and a strain level of 0.1%.

The “amount or content of at least one component X” in a composition, for example “the amount of the at least one polymer P1” refers to the sum of the individual amounts of all polymers P1 contained in the composition. Furthermore, in case the composition comprises 20 wt.-% of at least one polymer P1, the sum of the amounts of all polymers P1 contained in the composition equals 20 wt.-%.

The term “normal room temperature” refers to the temperature of 23° C.

The method for producing a waterbar comprises a first step 1), where two sealing elements having a carrier layer and a functional layer covering at least a portion of the upper major surface of the carrier layer are provided.

The carrier layer is preferably a sheet-like element having top and bottom surfaces, i.e., upper and lower major surfaces, and a thickness defined there between.

Preferably, the functional layer covers in each sealing element covers at least 75%, more preferably at least 85%, more preferably at least 95%, even more preferably at least 97.5%, still more preferably at least 99%, of the whole area of the upper major surface of the carrier layer.

In one or more embodiments, the functional layer covers substantially the whole area of the upper major surface of the carrier layer. The wording “substantially whole area” is understood to mean that the functional layer extends between the opposite longitudinal and transverse edges of the carrier layer as a continuous layer of material. However, it is possible for the functional layer to contain small holes, the size of which is negligeable compared to the total area of the functional layer, such as less than 0.01%, preferably less than 0.005%, more preferably less than 0.001%, of the total surface area of the functional layer.

In step II) of the method, the first and second sealing elements are bonded to each other such that their carrier layers become directly or indirectly connected to each other over at least parts of their opposing lower major surfaces.

The expression “directly connected” is understood to mean in the context of the present invention that no further layer or substance, such as an adhesive layer, is present between the bonded layers, and that the opposing surfaces of the two layers are directly connected to, particularly bonded to each other. At the transition area between the two layers, the materials forming the layers can also be present mixed with each other.

The first and second sealing elements can also be bonded to each other such that their carrier layers become indirectly connected to each other, for example, via a connecting layer, such as a layer of adhesive or via a fiber-based reinforcement layer, or a combination thereof. In case a porous connecting layer, such as an open weave fabric, the carrier layers can become partially directly and partially indirectly connected to each other.

Preferably, at least 90%, more preferably at least 95%, even more preferably at least 97.5%, still more preferably at least 99% of the lower major surface of the carrier layer of the second sealing element is directly or indirectly bonded to the lower major surface of the carrier layer of the first sealing element.

In one or more embodiments, step II) of the method is conducted by thermally or adhesively laminating the lower major surface of the carrier layer of the first sealing element to at least a portion of the lower major surface of the carrier layer of the second sealing element.

The term “thermal lamination” refers in the present disclosure to a process in which the respective layers are bonded to each other by the application of heat and pressure, such that the layers remain adhered to each other when the pressure is removed.

In one or more embodiments, the thermal lamination in step II) of the method comprises applying sufficient heat energy to at least one of the lower major surfaces of the carrier layers of the first and second sealing elements to at least partially melt the composition forming the respective layer(s) followed by contacting the opposing lower major surfaces of the carrier layers with each other, preferably under the influence of pressure, and cooling the layers resulting in formation of a bond between the carrier layers of the first and second sealing element without use of an adhesive. The application of heat energy in the thermal lamination step can be conducted, for example, using laser, hot-air, or infrared heating means.

In one or more further embodiments, the adhesive lamination in step II) of the method comprises applying an adhesive composition as an adhesive layer to a lower major surface of the first sealing element followed by contacting the opposing lower major surface of the second sealing element with the surface of the adhesive layer, optionally under the influence of pressure, to effect a formation of an adhesive bond between the carrier layers of the first and second sealing elements.

The adhesive lamination in step II) may also contain further sub-steps depending on the type of the adhesive. For example, in case a hot-melt adhesive is used in the adhesive lamination, the adhesive composition is preferably heated and applied to a lower major surface of the first sealing element as a melt, wherein the adhesive lamination further comprises cooling of the adhesive layer after the lower major surface of the carrier layer of the second sealing element has been contacted with the adhesive layer resulting in formation of an adhesive bond between the carrier layers of the first and second sealing elements.

Suitable adhesives for use in the adhesive lamination include, for example, reactive and non-reactive hot-melt adhesives, pressure sensitive adhesives, and one- and multiple-part reactive adhesives, particularly reactive epoxy, acrylic, and polyurethane adhesives.

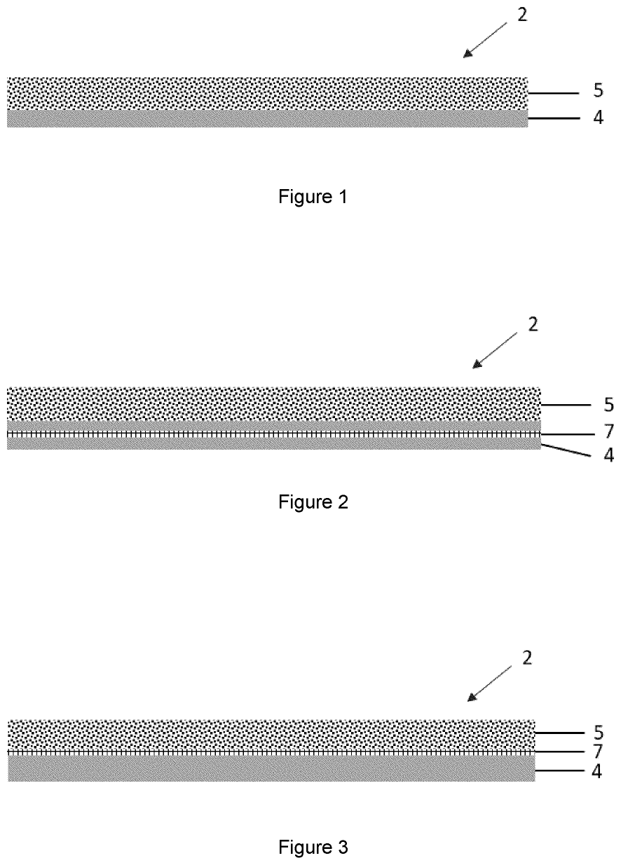

In one or more embodiments, at least one of the first and second sealing elements further comprise a reinforcement layer fully embedded into the carrier layer, as shown in FIG. 2, or located between the carrier layer and the functional layer, as shown in FIG. 3. The expression “fully embedded” is understood to mean that the reinforcement layer is substantially fully covered by the matrix of the carrier layer.

The reinforcement layer may be used to ensure the mechanical stability of the first and second sealing elements when the waterbar is exposed to varying environmental conditions.

Preferably, the reinforcement layer is selected from the group consisting of non-woven fabrics, woven fabrics, and laid scrims, more preferably from non-woven fabrics and laid scrims.

The term “non-woven fabric” designates in the present disclosure materials composed of fibers, which are bonded together by using chemical, mechanical, or thermal bonding means, and which are neither woven nor knitted. Non-woven fabrics can be produced, for example, by using a carding or needle punching process, in which the fibers are mechanically entangled to obtain the nonwoven fabric. In chemical bonding, chemical binders such as adhesive materials are used to hold the fibers together in a non-woven fabric.

Preferred non-woven fabrics for use as the reinforcement layer comprise synthetic organic and/or inorganic fibers. Particularly suitable synthetic organic fibers for the non-woven fabric include, for example, polyester fibers, polypropylene fibers, polyethylene fibers, nylon fibers, and polyamide fibers whereas particularly suitable inorganic fibers include, for example, glass fibers, aramid fibers, wollastonite fibers, and carbon fibers.

The term “laid scrim” refers in the present disclosure web-like non-woven products composed of at least two sets of parallel yarns (also designated as weft and warp yarns), which lay on top of each other and are chemically bonded to each other. The yarns of a non-woven scrim are typically arranged with an angle of 60-120°, such as 90±5°, towards each other thereby forming interstices, wherein the interstices occupy more than 60% of the entire surface area of the laid scrim. Typical materials for laid scrims include metal fibers, inorganic fibers, particularly glass fibers, and synthetic organic fibers, in particular polyester, polypropylene, polyethylene, and polyethylene terephthalate (PET).

According to one or more embodiments, the reinforcement layer is a non-woven fabric or a laid scrim, preferably having a mass per unit weight of not more than 500 g/m², more preferably not more than 350 g/m². In one or more embodiments, the reinforcement layer has a mass per unit weight of 10-500 g/m², preferably 20-400 g/m², more preferably 25-300 g/m², even more preferably 30-200 g/m².

In one or more embodiments, the method comprises a further step of providing a reinforcing layer, wherein step II) of bonding the first and second sealing element to each other is conducted in such a manner that the reinforcing layer becomes sandwiched between the carrier layers of the first and second sealing elements. FIG. 6 shows a cross-section of a waterbar having a reinforcing layer sandwiched between the carrier layers of the first and second sealing elements.

Depending on the type of the reinforcing layer, particularly on porosity of the reinforcing layer, the carrier layers of the first and second sealing elements can become indirectly connected or partially directly and partially indirectly connected to each other.

The preferences given above for the reinforcement layer are also applicable for the reinforcing layer.

The method for producing a waterbar according to the present invention can be conducted by using any conventional lamination techniques, particularly using any conventional laminating machines, which are also known to the skilled person. The method for producing a waterbar can be conducted, for example, using thermal lamination machine equipped with an infrared heating apparatus.

Preferably, the carrier layer comprises at least 35 wt.-%, preferably at least 50 wt.-%, more preferably at least 75 wt.-%, even more preferably at least 85 wt.-%, based on the total weight of the carrier layer, of the at least one polymer P1.

The at least one polymer P1 is preferably selected from ethylene vinyl acetate copolymers, polyvinylchloride, polyolefins, halogenated polyolefins, rubbers, and ketone ethylene esters.

Suitable polyvinylchloride resins have a K-value determined by using the method as described in ISO 1628-2-1998 standard in the range of 50-85, more preferably 65-75. The K-value is a measure of the polymerization grade of the PVC-resin and it is determined from the viscosity values of the PVC homopolymer as virgin resin, dissolved in cyclohexanone at 30° C.

Suitable copolymers of ethylene and vinyl acetate (EVA) include those having a content of a structural unit derived from vinyl acetate in the range of 4-95 wt.-%, preferably 6-90 wt.-%, based on the weight of the copolymer. Particularly suitable ethylene vinyl acetate copolymers include ethylene vinyl acetate bipolymers and terpolymers, such as ethylene vinyl acetate carbon monoxide terpolymers.

Suitable ethylene vinyl acetate copolymers are commercially available, for example, under the trade name of Escorene® (from Exxon Mobil), under the trade name of Primeva® (from Repsol Quimica S.A.), under the trade name of Evatane® (from Arkema Functional Polyolefins), under the trade name of Greenflex® from Eni versalis S.p.A., and under the trade name of Levapren® from Arlanxeo GmbH.

Suitable polyolefins include, for example, polyethylenes, ethylene copolymers, polypropylenes, and propylene copolymers.

Suitable polyethylenes include, for example, low density polyethylene (LDPE), linear low density polyethylene (LLDPE), and high density polyethylene (HDPE), preferably having a melting temperature (Tₘ) determined by differential scanning calorimetry (DSC) according to ISO 11357-3:2018 standard using a heating rate of 2° C./min of at or above 100° C., preferably at or above 105° C., more preferably at or above 110° C.

Further suitable polyethylenes include ethylene α-olefin copolymers, particularly random and block copolymers of ethylene and one or more C₃-C₂₀ α-olefin monomers, especially one or more of propylene, 1-butene, 1-pentene, 1-hexene, 1-heptene, 1-octene, 1-decene, 1-dodecene, and 1-hexadodecene, preferably comprising at least 60 wt.-%, more preferably at least 65 wt.-% of ethylene-derived units, based on the weight of the copolymer.

Suitable ethylene α-olefin random copolymers include, for example, ethylene-based plastomers, which are commercially available, for example, under the trade name of Affinity®, such as Affinity® EG 8100G, Affinity@EG 8200G, Affinity@SL 8110G, Affinity@KC 8852G, Affinity® VP 8770G, and Affinity® PF 1140G (all from Dow Chemical Company); under the trade name of Exact@, such as Exact@3024, Exact@3027, Exact@3128, Exact@3131, Exact@4049, Exact@4053, Exact@5371, and Exact@8203 (all from Exxon Mobil); and under the trade name of Queo® (from Borealis AG) as well as ethylene-based polyolefin elastomers (POE), which are commercially available, for example, under the trade name of Engage®, such as Engage® 7256, Engage@7467, Engage@7447, Engage® 8003, Engage® 8100, Engage® 8480, Engage® 8540, Engage® 8440, Engage® 8450, Engage® 8452, Engage® 8200, and Engage® 8414 (all from Dow Chemical Company).

Suitable ethylene α-olefin block copolymers include ethylene-based olefin block copolymers (OBC), which are commercially available, for example, under the trade name of Infuse®, such as Infuse® 9100, Infuse® 9107, Infuse® 9500, Infuse® 9507, and Infuse® 9530 (all from Dow Chemical Company).

Suitable polypropylenes include, for example, isotactic polypropylene (iPP), syndiotactic polypropylene (sPP), and homopolymer polypropylene (hPP), preferably having a melting temperature (Tₘ) determined by differential scanning calorimetry (DSC) according to ISO 11357-3:2018 standard using a heating rate of 2° C./min of at or above 100° C., preferably at or above 105° C., more preferably at or above 110° C.

Further suitable polypropylenes include propylene α-olefin copolymers, such as random and block copolymers of propylene and ethylene and random and block copolymers of propylene and one or more C₄-C₂₀ α-olefin monomers, in particular one or more of 1-butene, 1-pentene, 1-hexene, 1-heptene, 1-octene, 1-decene, 1-dodecene, and 1-hexadodecene, preferably comprising at least 60 wt.-%, more preferably at least 65 wt.-% of propylene-derived units, based on the weight of the copolymer.

Suitable propylene α-olefin random and block copolymers are commercially available, for example, under the trade names of Intune®, and Versify (from Dow Chemical Company) and under the trade name of Vistamaxx® (from Exxon Mobil).

Further suitable polypropylenes also include heterophasic propylene copolymers. These are heterophasic polymer systems comprising a high crystallinity base polyolefin and a low-crystallinity or amorphous polyolefin modifier. The heterophasic phase morphology consists of a matrix phase composed primarily of the base polyolefin and a dispersed phase composed primarily of the polyolefin modifier. Suitable commercially available heterophasic propylene copolymers include reactor blends of the base polyolefin and the polyolefin modifier, also known as “in-situ TPOs” or “reactor TPOs or “impact copolymers (ICP)”, which are typically produced in a sequential polymerization process, wherein the components of the matrix phase are produced in a first reactor and transferred to a second reactor, where the components of the dispersed phase are produced and incorporated as domains in the matrix phase. Heterophasic propylene copolymers comprising polypropylene homopolymer as the base polymer are often referred to as “heterophasic propylene copolymers (HECO)” whereas heterophasic propylene copolymers comprising polypropylene random copolymer as the base polymer are often referred to as “heterophasic propylene random copolymers (RAHECO)”. The term “heterophasic propylene copolymer” encompasses in the present disclosure both the HECO and RAHECO types of the heterophasic propylene copolymers.

Depending on the amount of the polyolefin modifier, the commercially available heterophasic propylene copolymers are typically characterized as “impact copolymers” (ICP) or as “reactor-TPOs” or as “soft-TPOs”. The main difference between these types of heterophasic propylene copolymers is that the amount of the polyolefin modifier is typically lower in ICPs than in reactor-TPOs and soft-TPOs, such as not more than 40 wt.-%, particularly not more than 35 wt.-%. Consequently, typical ICPs tend to have a lower xylene cold soluble (XCS) content determined according to ISO 16152 2005 standard as well as higher flexural modulus determined according to ISO 178:2010 standard compared to reactor-TPOs and soft-TPOs.

Suitable heterophasic propylene copolymers include reactor TPOs and soft TPOs produced with LyondellBasell's Catalloy process technology, which are commercially available under the trade names of Adflex®, Adsyl®, Clyrell®, Hifax®, Hiflex®, and Softell®, such as Hifax® CA 10A, Hifax® CA 12A, and Hifax® CA 60 A, and Hifax CA 212 A. Further suitable heterophasic propylene copolymers are commercially available under the trade name of Borsoft® (from Borealis Polymers), such as Borsoft® SD233 CF.

Suitable rubbers include, for example, butyl rubber, halogenated butyl rubber, ethylene-propylene diene monomer rubber (EPDM), natural rubber, chloroprene rubber, synthetic 1,4-cis-polyisoprene, polybutadiene, ethylene-propylene rubber (EPR), styrene-butadiene rubber (SBR), isoprene-butadiene copolymer, styrene-isoprene-butadiene rubber, methyl methacrylate-butadiene copolymer, methyl methacrylate-isoprene copolymer, acrylonitrile-isoprene copolymer, and acrylonitrile-butadiene copolymer.

The carrier layer may further comprise one or more additives such as fillers, UV-and heat stabilizers, antioxidants, flame retardants, dyes, pigments such as titanium dioxide, matting agents, antistatic agents, impact modifiers, biocides, and processing aids such as lubricants, slip agents, antiblock agents, and denest aids. It is however preferred, that the total weight of these types of additives makes up not more than 50 wt.-%, preferably not more than 35 wt.-%, more preferably not more than 15 wt.-%, of the total weight of the carrier layer.

The carrier layer preferably has a thickness measured by using the method as defined in EN 1849-2:2019 standard of 0.15-5 mm, preferably 0.25-3.5 mm, more preferably 0.35-3 mm, even more preferably 0.5-2.5 mm.

According to the present invention, the functional layer is operative to bond with a fresh cementitious composition casted against it and allowed to harden. The term “operative to bond with a cementitious composition” is understood to mean that that the functional layer forms a permanent bond to a fresh cementitious composition casted against it after hardening.

Furthermore, the term “cementitious composition” refers here to concrete, shotcrete, grout, mortar, paste or a combination thereof. The terms “paste”, “mortar”, “concrete”, “shotcrete”, and “grout” are well-known terms in the state-of-the-art. Pastes are mixtures comprising a hydratable cement binder, usually Portland cement, masonry cement, or mortar cement. Mortars are pastes additionally including fine aggregate, for example sand.

Concrete are mortars additionally including coarse aggregate, for example crushed gravel or stone. Shotcrete is concrete (or sometimes mortar) conveyed through a hose and pneumatically projected at high velocity onto a surface. Grout is a particularly flowable form of concrete used to fill gaps. The cementitious compositions can be formed by mixing required amounts of certain components, for example, a hydratable cement, water, and fine and/or coarse aggregate, to produce the particular cementitious composition. The term “fresh cementitious composition” or “liquid cementitious composition” designate cementitious compositions before hardening, particularly before setting.

The functional layer is preferably selected from a layer of fiber material, a filled polymeric layer, a bitumen-based layer, and a layer of pressure sensitive adhesive.

According to one or more embodiments, the functional layer comprises or is a layer of fiber material.

The term “fiber material” designates in the present document materials composed of fibers comprising or consisting of, for example, organic, inorganic, or synthetic organic materials.

Examples of organic fibers include, for example, cellulose fibers, cotton fibers, and protein fibers. Particularly suitable synthetic organic materials include, for example, polyester, homopolymers and copolymers of ethylene and/or propylene, viscose, nylon, and polyamides. Fiber materials composed of inorganic fibers are also suitable, particular, those composed of metal fibers or mineral fibers, such as glass fibers, aramid fibers, wollastonite fibers, and carbon fibers. Inorganic fibers, which have been surface treated, for example, with silanes, may also be suitable. The fiber material can comprise short fibers, long fibers, spun fibers (yarns), or filaments. The fibers can be aligned or drawn fibers. It may also be advantageous that the fiber material is composed of different types of fibers, both in terms of geometry and composition.

Preferably, the layer of fiber material is selected from the group consisting of non-woven fabrics, woven fabrics, and laid scrims.

According to one or more embodiments, the layer of fiber material is a non-woven fabric, preferably having a mass per unit weight of not more than 350 g/m², preferably not more than 300 g/m². According one or more embodiments, the layer of fiber material is a non-woven fabric having a mass per unit weight of 15-300 g/m², preferably 20-250 g/m², more preferably 25-200 g/m², even more preferably 30-150 g/m².

Preferably, the non-woven fabric of the layer of fiber material comprises synthetic organic and/or inorganic fibers. Particularly suitable synthetic organic fibers for the non-woven fabric include, for example, polyester fibers, polypropylene fibers, polyethylene fibers, nylon fibers, and polyamide fibers. Particularly suitable inorganic fibers for the non-woven fabric include, for example, glass fibers, aramid fibers, wollastonite fibers, and carbon fibers.

According to one or more embodiments, the non-woven fabric of the layer of fiber material has as the main fiber component synthetic organic fibers, preferably selected from the group consisting of polyester fibers, polypropylene fibers, polyethylene fibers, nylon fibers, and polyamide fibers. According to one or more further embodiments, the non-woven fabric has as the main fiber component inorganic fibers, preferably selected from the group consisting of glass fibers, aramid fibers, wollastonite fibers, and carbon fibers, more preferably glass fibers.

According to one or more embodiments, the functional layer comprises or is a filled polymeric layer.

Preferably, the filled polymeric layer comprises:
a) 25-75 wt.-%, preferably 35-70 wt.-%, more preferably 40-65 wt.-%, even more preferably 45-65 wt.-%, of at least one polymer P2 and
b) 15-65 wt. %, preferably 25-60 wt.-%, more preferably 30-55 wt.-%, even more preferably 35-50 wt.-%, of a least one solid particulate filler F, all proportions being based on the total weight of the filled polymeric layer.

Preferably, the at least one polymer P2 is selected from ethylene vinyl acetate copolymers, polyvinylchloride, polyolefins, halogenated polyolefins, rubbers, and ketone ethylene esters, more preferably from ethylene vinyl acetate copolymers, polyolefins, and polyvinylchloride.

According to one or more embodiments, the at least one polymer P2 comprises at least one ethylene vinyl acetate copolymer P21.

Generally, the expression “the at least one component X comprises at least one component XN”, such as “the at least one polymer P2 comprises at least one ethylene vinyl acetate copolymer P21” is understood to mean in the context of the present disclosure that the composition comprises one or more ethylene vinyl acetate copolymers P21 as representatives of the at least one polymer P2.

Preferably the at least one ethylene vinyl acetate copolymer P21 has a content of a structural unit derived from vinyl acetate of at least 5 wt.-%, more preferably at least 15 wt.-%, even more preferably at least 25 wt.-%, still more preferably at least 35 wt.-%, most preferably at least 40 wt.-%, based on the weight of the copolymer.

According to one or more embodiments, the at least one ethylene vinyl acetate copolymer P21 has a content of a structural unit derived from vinyl acetate of 5-95 wt.-%, preferably 15-90 wt.-%, more preferably 25-90 wt.-%, even more preferably 35-90 wt.-%, based on the weight of the copolymer. According to one or more preferred embodiments, the at least one ethylene vinyl acetate copolymer P21 has a content of a structural unit derived from vinyl acetate of 30-95 wt.-%, preferably 40-90 wt.-%, more preferably 45-90 wt.-30%, based on the weight of the copolymer.

Ethylene vinyl acetate copolymers having the content of a structural unit derived from vinyl acetate in the above cited ranges are especially suitable for use in the filled polymeric layer since they have been found out to provide the functional layer with an improved ability to form a bond with a fresh cementitious composition after hardening.

According to one or more embodiments, the at least one ethylene vinyl acetate copolymer P21 comprises at least 15 wt.-%, preferably at least 25 wt.-%, more preferably at least 35 wt.-%, still more preferably at least 50 wt.-%, of the total weight of the at least one polymer P2.

According to one or more embodiments, the at least one polymer P2 further comprises at least one polymer P22 different from the at least one ethylene vinyl acetate copolymer P21, preferably selected from polyolefins, halogenated polyolefins, polyvinylchloride, and ketone ethylene esters.

Suitable polyolefins for use as the at least one polymer P22 include, for example, polyethylenes, ethylene copolymers, polypropylenes, and propylene copolymers as discussed above.

Preferably, the proportion of the at least one polymer P22 makes up not more than 75 wt.-%, preferably not more than 65 wt.-%, more preferably not more than 55 wt.-%, even more preferably not more than 45 wt.-%, of the total weight of the at least one polymer P2.

According to one or more embodiments, the proportion of the at least one polymer P22 makes up 2.5-65 wt.-%, preferably 5-55 wt.-%, more preferably 10-50 wt.-%, even more preferably 15-45 wt.-%, of the total weight of the at least one polymer P2.

Preferably, the at least one solid particulate filler F is selected from the group consisting of inert mineral fillers, mineral binders, and synthetic organic fillers. According to one or more embodiments, the particles of the at least one solid particulate filler F are distributed throughout the entire volume of the filled polymeric layer. The term “distributed throughout” means that essentially all portions of the filled polymeric layer contain particles of the at least one filler but it does not necessarily imply that the distribution of the particles is completely uniform throughout the filled polymeric layer.

It may also be preferable that the filled polymeric layer comprises a homogeneously mixed mixture of the at least one polymer P2 and the at least one solid particulate filler F. A “homogeneously mixed mixture” refers in the present disclosure to compositions, in which the individual constituents are distributed substantially homogeneously in the composition. A homogeneously mixed mixture of the at least one polymer P2 and the at least one solid particulate filler F refers, therefore, to compositions in which the particles of the at least one solid particulate filler F are homogeneously/uniformly distributed in a polymer phase comprising the at least one polymer P2. For a person skilled in the art it is clear that within such mixed compositions there may be regions formed, which have a slightly higher concentration of one of the constituents than other regions and that a 100% homogeneous distribution of all the constituents is generally not achievable. Such mixed compositions with “imperfect” distribution of constituents, however, are also intended to be included by the term “homogeneously mixed mixture” in accordance with the present invention.

Preferably, the at least one solid particulate filler F has:
a d₉₈ particle size of not more than 500 μm, more preferably not more than 350 μm, even more preferably not more than 250 μm, still more preferably not more than 100 μm and/or
a median particle size d₅₀ of not more than 150 μm, more preferably not more than 100 μm, even more preferably not more than 50 μm, still more preferably not more than 25 μm and/or
d₁₀ particle size of not more than 25 μm, more preferably not more than 15 μm, even more preferably not more than 5 μm, still more preferably not more than 2.5 μm.

The term “particle size” refers in the present disclosure to the area-equivalent spherical diameter of a particle (Xₐᵣₑₐ). The term d₉₀ particle size refers in the present disclosure to a particle size below which 90% of all particles by volume are smaller than the d₉₀ value. In analogy, the term “median particle size d₅₀” refers to a particle size below which 50% of all particles by volume are smaller than the d₅₀ value and the term “d₁₀ particle size” refers to a particle size below which 10% of all particles by volume are smaller than the d₁₀ value.

A particle size distribution can be measured by laser diffraction according to the method as described in standard ISO 13320:2009 using a wet or dry dispersion method and a Mastersizer 2000 device (trademark of Malvern Instruments Ltd, GB).

According to one or more embodiments, the at least one solid particulate filler F has a median particle size d₅₀ in the range of 0.1-50 μm, preferably 0.15-35 μm, more preferably 0.25-25 μm, even more preferably 0.35-20 μm, still more preferably 0.35-15 μm, most preferably 0.5-10 μm.

According to one or more embodiments, the at least one solid particulate filler F is selected from the group consisting of inert mineral fillers and mineral binders.

According to one or more embodiment, the at least one solid particulate filler F comprises at least one inert mineral filler F1.

The term “inert mineral filler” refers to mineral fillers, which, unlike mineral binders do not undergo a hydration reaction in the presence of water. Suitable mineral fillers to be used as the inert mineral filler F1 include, for example, sand, granite, calcium carbonate, magnesium carbonate, clay, expanded clay, diatomaceous earth, pumice, mica, kaolin, dolomite, xonotlite, perlite, vermiculite, Wollastonite, barite, cristobalite, silica, fumed silica, fused silica, glass beads, hollow glass spheres, ceramic spheres, bauxite, comminuted concrete, and zeolites.

The term “sand” refers in the present document mineral clastic sediments (clastic rocks) which are loose conglomerates (loose sediments) of round or angular small grains, which were detached from the original grain structure during the mechanical and chemical degradation and transported to their deposition point, said sediments having an SiO₂ content of greater than 50 wt.-%, in particular greater than 75 wt.-%, particularly preferably greater than 85 wt.-%. The term “calcium carbonate” when used as inert mineral filler refers to solid particulate substances produced from chalk, limestone, or marble by grinding and/or precipitation.

According to one or more embodiments, the at least one inert mineral filler F1 is selected from the group consisting of sand, granite, calcium carbonate, magnesium carbonate, clay, expanded clay, diatomaceous earth, pumice, mica, kaolin, potash, dolomite, xonotlite, perlite, vermiculite, Wollastonite, barite, cristobalite, silica (quartz), fumed silica, fused silica, bauxite, comminuted concrete, and zeolites, preferably from the group consisting of calcium carbonate, magnesium carbonate, diatomaceous earth, pumice, mica, dolomite, xonotlite, perlite, vermiculite, Wollastonite, barite, and comminuted concrete.

According to one or more embodiments, the at least one solid particulate filler F is composed of the at least one inert mineral filler F1.

According to one or more embodiment, the at least one solid particulate filler F comprises at least one mineral binder F2.

The term “mineral binder” refers in the present disclosure to mineral materials, which undergo a hydration reaction in the presence of water. Particularly, the term “mineral binder” refers to non-hydrated mineral binders, i.e. to unreacted mineral binders that have not yet reacted in a hydration reaction.

Suitable mineral binders for use as the at least one solid particulate filler F include hydraulic binders, such as cement and hydraulic lime, calcium sulfates, and air-hardening binders, such as non-hydrated lime, and latent hydraulic and pozzolanic binder materials.

According to one or more embodiment, the at least one mineral binder F2 comprises at least one hydraulic binder.

The term “hydraulic binder” refers the present document an inorganic material or blend, which forms a paste when mixed with water, and which sets and hardens by a series of hydration reactions resulting in formation of solid mineral hydrates or hydrate phases, which are not soluble in water or have a very low water-solubility. Hydraulic binders, such as Portland cement, can harden and retain their strength even when exposed to water, for example underwater or under high humidity conditions. In contrast, the term “non-hydraulic binder” refers to substances, which harden by reaction with carbon dioxide and which, therefore, do not harden in wet conditions or under water.

Preferred hydraulic binders for use as the at least one mineral binder F2 include Portland cement, aluminate cement, and calcium sulfoaluminate cement.

The term “Portland cement” as used herein is intended to include those cements normally understood to be “Portland cements”, particularly those described in European Standard EN-197. Portland cement consists mainly of tri-calcium silicate (alite) (C₃S) and dicalcium silicate (belite) (C₂S). Preferred Portland cements include the types CEM I, CEM II, CEM III, CEM IV, and CEM V compositions of the European standard EN 197-1:2018-11.

However, all other Portland cements that are produced according to another standard, for example, according to ASTM standard, British (BSI) standard, Indian standard, or Chinese standard are also suitable.

The term “aluminate cement” as used herein is intended to include those cementitious materials that contain as the main constituent (phase) hydraulic calcium aluminates, preferably mono calcium aluminate CA (CaO·Al2O3). Depending on the type of the aluminate cement, other calcium aluminates, such as CA₂, C₃A, and C₁₂A₇, may also be present. Preferred aluminate cements include also other constituents, such as belite (C₂S), alite (C₃S), ferrites (C₂F, C₂AF, C₄AF), and ternesite (CsS₂ [symbol] ). Some aluminate cements also contain calcium carbonate.

Most preferred aluminate cements for use as the at least one mineral binder F2 include calcium aluminate cements (CAC), which fulfill the requirements of the norm EN 4647 (“Calcium Aluminate Cement”). Suitable calcium aluminate cements are commercially available, for example, from Imerys Aluminates and Royal White Cement.

The term “calcium sulfoaluminate cement (CSA)” is intended to include those cementitious materials that contain as the main constituent (phase) C4(A3-xFx)3 [symbol] (4CaO·3-x Al₂O₃·x Fe2O3·CaSO4), wherein x has a value of 0,1, 2, or 3. Typically, calcium sulfoaluminate cements also include other constituents, such as aluminates (CA, C₃A, C₁₂A₇), belite (C₂S), ferrites (C₂F, C₂AF, C₄AF), ternesite (CsS₂ [symbol] ), and calcium sulfate. Preferred calcium sulfoaluminate cements contain 20-80 wt.-% of ye'elimite (C4A3 [symbol] ), 0-10 wt.-% of calcium aluminate (CA), 0-70 wt.-% of belite (C₂S), 0-35 wt.-% of ferrite, preferably tetracalcium aluminoferrite (C₄AF), and 0-20 wt.-% of ternesite (C5S2 [symbol] ), based on the total weight of the calcium sulfoaluminate cement. Suitable calcium aluminate cements are commercially available, for example, from Heidelberg Cement AG, Vicat SA, and Caltra B.V.

According to one or more embodiments, the at least one mineral binder F2 is selected from the group consisting of Portland cement, calcium aluminate cement (CAC), and calcium sulfoaluminate cement (CSA).

According to one or more embodiments, the at least one mineral binder F2 comprises at least one non-hydraulic binder.

Examples of suitable non-hydraulic binders to be used as the at least one mineral binder F2 include air-slaked lime (non-hydraulic lime) and calcium sulfate. The term “calcium sulfate” is understood to include calcium sulfate anhydride (CaSO₄), calcium sulfate hemihydrate (CaSO₄·½ H₂O), and calcium sulfate dihydrate (CaSO₄·2 H₂O). Furthermore, the term “calcium sulfate hemihydrate” is understood to include both alpha and beta calcium sulfate hemihydrates. Preferred calcium sulfates include the ones derived from REA gypsum, phosphor gypsum, and nature gypsum. The term “REA gypsum” refers here to a gypsum obtained in so-called flue gas desulphurization plants.

According to one or more embodiments, the at least one mineral binder F2 comprises at least one latent hydraulic binder.

The term “latent hydraulic binder” refers in the present disclosure to type II concrete additives with a “latent hydraulic character” as defined in DIN EN 206-1:2000 standard. These types of mineral binders are calcium aluminosilicates that are not able to harden directly or harden too slowly when mixed with water. The hardening process is accelerated in the presence of alkaline activators, which break the chemical bonds in the binder's amorphous (or glassy) phase and promote the dissolution of ionic species and the formation of calcium aluminosilicate hydrate phases.

Examples of suitable latent hydraulic binders to be used as the at least one mineral binder F2 include ground granulated blast furnace slag. Ground granulated blast furnace slag is typically obtained from quenching of molten iron slag from a blast furnace in water or steam to form a glassy granular product and followed by drying and grinding the glassy into a fine powder.

According to one or more embodiments, the at least one mineral binder F2 comprises at least one pozzolanic binder.

The term “pozzolanic binder” refers in the present disclosure to type II concrete additives with a “pozzolanic character” as defined in DIN EN 206-1:2000 standard. These types of mineral binders are siliceous or aluminosilicate compounds that react with water and calcium hydroxide to form calcium silicate hydrate or calcium aluminosilicate hydrate phases.

Examples of suitable pozzolanic binders to be used as the at least one mineral binder F2 include natural pozzolans, such as trass, and artificial pozzolans, such as fly ash and silica fume. The term “fly ash” refers in the present disclosure to the finely divided ash residue produced by the combustion of pulverized coal, which is carried off with the gasses exhausted from the furnace in which the coal is burned. The term “silica fume” refers in the present disclosure to fine particulate silicon in an amorphous form. Silica fume is typically obtained as a by-product of the processing of silica ores such as the smelting of quartz in a silica smelter which results in the formation of silicon monoxide gas and which on exposure to air oxidizes further to produce small particles of amorphous silica.

According to one or more embodiment, the at least one solid particulate filler F comprises at least one synthetic organic filler F3.

Suitable synthetic organic materials to be used as the at least one synthetic organic filler F3 include in particular plastic materials having a melting temperature (Tₘ) determined by DSC according to ISO 11357 standard of at or above 250° C., preferably at or above 275° C., such as polyamide, aramid, epoxide, polystyrene, expanded polystyrene, polyethylene terephthalate (PET), poly(phenyl ethers), polysulfones, and polyethersulfones.

The at least one solid particulate filler F is preferably present in the filled polymeric layer as individual solid particles and/or as aggregates of one or more solid particles, wherein at least a portion of the solid particles and/or aggregates are dispersed in a continuous phase comprising the at least one polymer P2. The expression “dispersed in a continuous phase” is understood to mean that the individual solid particles or aggregates of one or more solid particles are at least partially, preferably completely surrounded by the continuous phase comprising the at least one polymer P2.

According to one or more embodiments at least 50 wt.-%, preferably at least 75 wt.-%, more preferably at least 95 wt.-%, even more preferably at least 99 wt.-%, still more preferably at least 99.9 wt.-%, of the particles of the at least one solid particulate filler F are dispersed in a continuous phase comprising the at least one polymer P2.

The filled polymeric layer can further comprise one or more additives, for example, UV-and heat stabilizers, antioxidants, plasticizers, flame retardants, dyes, pigments such as titanium dioxide and carbon black, matting agents, antistatic agents, impact modifiers, biocides, and processing aids such as lubricants, slip agents, antiblock agents, and denest aids. The total proportion of such additives is preferably not more than 10 wt.-%, more preferably not more than 5 wt.-%, even more preferably not more than 2.5 wt.-%, based on the total weight of the filled polymeric layer.

According to one or more embodiments, the mass per unit area of the filled polymeric layer is in the range of 100-10000 g/m², preferably 150-7500 g/m², more preferably 200-5000 g/m², even more preferably 250-3500 g/m², still more preferably 300-2500 g/m², most preferably 350-1500 g/m².

The filled polymeric layer can be obtained, for example, by using a method comprising a step of extruding or co-extruding a first melt-processed composition comprising the constituents of the filled polymeric layer through an extruder die.

The first melt-processed composition is preferably obtained by melt-processing a first starting composition comprising the constituents of the filled polymeric layer.

The term “melt-processing” refers in the present disclosure to a process, in which at least one molten polymeric component is intimately mixed with at least one other component, which may be another molten polymeric component or a solid component, such as a filler or a catalyst, until a melt blend, i.e. a substantially homogeneously mixed mixture of the polymeric component(s) and the other constituents is obtained.

The melt processing of a starting composition can be conducted as a batch process using any conventional mixer, such as a Brabender, Banbury, or roll mixer or as continuous process using a continuous type of mixer, preferably an extruder, such as a single screw or a twin-screw extruder or a planetary roller extruder. The constituents of the starting composition are preferably fed into the mixer using a conventional feeding system comprising a feed hopper and feed extruder. Alternatively, some or all the constituents of the starting composition may be directly fed into the mixer as individual streams, as a pre-mix, or as a master batch. Furthermore, the constituents of the starting composition can first be processed in a compounding extruder to pellets or granules, which are then fed into the mixer.

Especially in case the at least one solid particulate filler F comprises hydraulic binders, it may be preferred that the first starting composition contains only minor amounts of water. According to one or more embodiments, the first starting composition comprises less than 10 wt.-%, preferably less than 7.5 wt.-%, more preferably less than 5 wt.-%, even more preferably less than 3.5 wt.-%, still more preferably less than 2.5 wt.-%, of water, based on the total weight of the first starting composition.

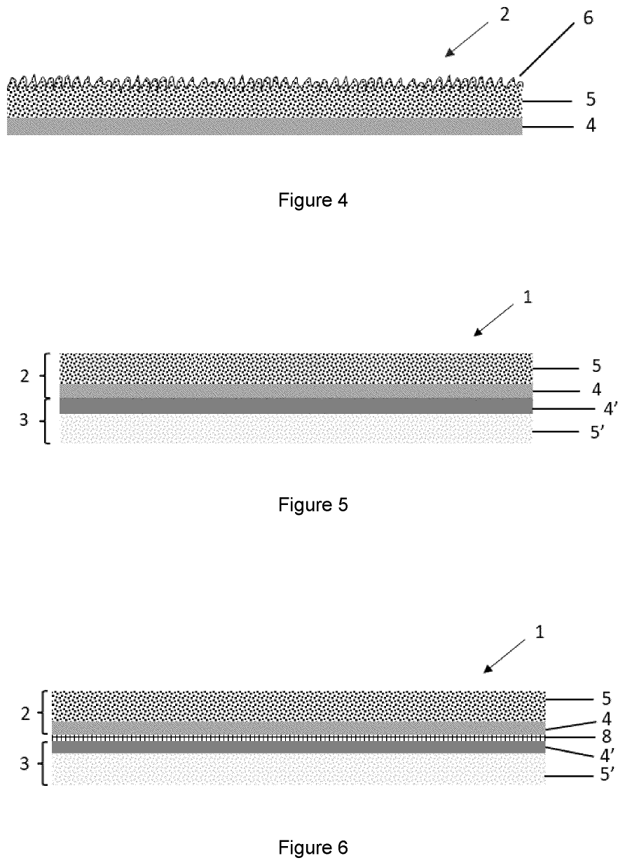

The upper major surface of the filled polymeric layer facing away from the carrier layer (4, 4′) may be substantially planar/smooth as shown in FIG. 1 or it can contain a surface structure (6), which can be characterized as surface roughness, as shown in FIG. 4. The term “surface roughness” refers to unevenness of a surface, which can be quantified, for example, by use of two-dimensional (2D) surface roughness parameters as defined in ISO 4287 standard and/or with three-dimensional (3D) surface roughness parameters defined as defined in ISO 25178 standard.

Such surface structure may improve the ability of the filled polymeric layer, i.e., the functional layer, to form a bond with a fresh cementitious compositions after hardening. The improved bonding may result from increased surface area of the filled polymeric layer, which enables the increased number of molecular interactions between the fresh cementitious composition and the surface of the filled polymeric layer compared to a filled polymeric layer having a smooth surface.

A filled polymeric layer having a surface structure can be obtained, for example, by using a foam extrusion process comprising a step of extruding or co-extruding the first melt-processed composition comprising the constituents of the filled polymeric layer and a blowing gas through an extruder die. On the other hand, a filled polymeric layer produced without foam extrusion and having a smooth surface can also be subjected to a mechanical surface treatment step, such as grinding, brushing, and abrasive blasting to produce the desired surface structure.

In case the first melt-processed composition comprises a blowing gas, the melt-shaped layer, i.e., the extruded profile, discharged from the extruder die is first inflated due to volume increase of the blowing gas resulting in formation of a closed cell structure. Eventually, surface(s) of the melt-shaped layer is penetrated by the still expanding blowing gas, which results in formation of open or semi-open cells, pores, cavities, and other surface imperfections, which can be characterized as “a surface structure”.

Physical and chemical blowing agents may be used to provide the first melt-processed composition with a blowing gas. Chemical blowing agents are preferably added to the first starting composition and the blowing gas is then generated during the melt-processing of the first starting composition. Physical blowing agents are preferably added directly to the first melt-processed composition before it is extruded through the extruder die.

Suitable physical blowing agents include gaseous and liquid physical blowing agents. Liquid physical blowing agents include volatile liquids which produce gas through vaporization. Suitable liquid physical blowing agents generally include water, short-chain aliphatic hydrocarbons, for example having from five to seven carbon atoms, and their halogenated, particularly chlorinated and fluorinated, derivatives. Particularly suitable liquid physical blowing agents have a standard boiling point measured at a pressure of 1 bar of not more than 250° C., preferably not more than 200° C. The standard boiling point of a liquid physical blowing agent can be measured using an ebulliometer. Gaseous physical blowing agents, such as compressed nitrogen or carbon dioxide, can be directly injected under high pressure into the polymer melt, which is conveyed through a melt-processing apparatus, such as an extruder barrel.

Chemical blowing agents, also known as chemical foaming agents, are typically solids that liberate gas(es) by means of a chemical reaction, such as decomposition, when exposed to elevated temperatures. Inorganic, organic, exothermic, and endothermic chemical blowing agents are all equally suitable. Endothermic blowing agents may be preferred over exothermic blowing agents, since the latter have been found to have potential to trigger respiratory sensitivity, are generally not safe from a toxicological point of view or have a risk of explosion. Furthermore, by-products such as ammonia, formamide, formaldehyde or nitrosamines are released during decomposition of exothermic blowing agents and these substances have been classified as hazardous substances.

In case of a foam extrusion process, the first starting composition preferably comprises at least one chemical blowing agent CBA.

Suitable substances to be used as the at least one chemical blowing agent CBA include, for example, azodicarbonamide, azobisisobutyronitrile, azocyclohexyl nitrile, dinitrosopentamethylene tetramine, azodiamino benzene, calcium azide, 4,4′-diphenyldisulphonyl azide, benzenesulphonyl hydrazide, 4,4-oxybenzenesulphonyl semicarbazide, 4,4-oxybis(benzenesulphonyl hydrazide), diphenyl sulphone-3,3-disulphonyl hydrazide, p-toluenesulphonyl hydrazide, p-toluenesulphonyl semicarbazide, trihydrazino triazine, N,N′-dimethyl-N,N′-dinitrosoterephthalamide, diazoaminobenzene, diazoaminotoluene, hydrazodicarbonamide, barium azodicarboxylate, 5-hydroxytetrazole, sodium bicarbonate, ammonium carbonate, ammonium bicarbonate, potassium bicarbonate, and organic acids.

Suitable organic acids for use as the at least one chemical blowing agent CBA include, for example, monocarboxylic acids, such as acetic acid and propionic acid, solid polycarboxylic acids, such as solid, hydroxy-functionalized or unsaturated dicarboxylic, tricarboxylic, tetracarboxylic or polycarboxylic acids, in particular citric acid, tartaric acid, malic acid, fumaric acid, and maleic acid.

Although some of the compounds used in the present invention are characterized as useful for specific functions, the use of these compounds is not limited to their stated functions. For example, it is also possible that some of the substances presented above as chemical blowing agents can also be used as activators for the at least one chemical blowing agent CBA.

For example, commonly used activators for organic acid-based chemical blowing agents include hydrogen carbonate (bicarbonate) and carbonate salts, especially those of formula XHCO₃ or X₂CO₃, wherein X stands for a generic cation, such as Na⁺, K⁺, NH₄⁺, % Zn²⁺, ½ Mg²⁺, and ½ Ca2+, in particular Na⁺ and K⁺. On the other hand, these types of activators may themselves be suitable for use as the at least one chemical blowing agent CBA.

According to one or more embodiments, the at least one chemical blowing agent CBA is selected from the group consisting of bicarbonates of formula XHCO₃ and carbonates of formula X₂CO₃, wherein X stands for a generic cation, in particular Na⁺, K⁺, NH₄+, ½ Zn²⁺, ½ Mg²⁺, or ½ Ca²⁺, preferably from the group consisting of bicarbonates of formula XHCO₃, wherein X stands for a generic cation, in particular Na⁺, K⁺, NH₄+, ½ Zn²⁺, ½ Mg²⁺, or ½ Ca²⁺, more preferably from the group consisting of sodium and potassium bicarbonates.

According to one or more embodiments, the at least one chemical blowing agent CBA has a maximum decomposition peak temperature measured by Differential Scanning Calorimetry (DSC) in the range of 85-225° C., preferably 95-215° C., more preferably 105-205° C., even more preferably 115-195° C. The maximum decomposition peak measured by DSC is preferably determined by using a DSC822e differential scanning calorimeter from Mettler-Toledo by keeping the sample for 2 min at 25° C., then heating the sample from 25° C. to 280° C. at a rate of 5° C./min, then keeping the sample for 2 min at 280° C. and finally cooling the sample from 280° C. to 25° C. at a rate of 10° C./min.

According to one or more embodiments, the at least one chemical blowing agent CBA is present in the starting composition in form of solid particles having a median particle size d₅₀ in the range of 0.5-100 μm, preferably 1.0-75 μm, more preferably 2.5-50 μm, even more preferably 5-35 μm.

The proportion of the at least one chemical blowing agent CBA, if used, preferably makes up not more than 3.5 wt.-%, more preferably not more than 2.5 wt.-%, even more preferably not more than 2 wt.-%, still more preferably not more than 1.5 wt.-%, of the total weight of the first starting composition.

Preferably, the proportion of the at least one chemical blowing agent CBA, if used, makes up at least 0.05 wt.-%, preferably at least 0.1 wt.-%, more preferably at least 0.15 wt.-%, of the total weight of the first starting composition. According to one or more embodiments, the proportion of the at least one chemical blowing agent CBA makes up 0.01-2.5 wt.-%, preferably 0.1-2.0 wt.-%, more preferably 0.15-1.5 wt.-%, even more preferably 0.25-1.25 wt.-%, still more preferably 0.35-1.25 wt.-%, of the total weight of the first starting composition.

The preferred extrusion temperature depends on the embodiment of the filled polymeric layer, in particular on the type of the at least one polymer P2. The term “extrusion temperature” refers to the temperature of the extruded composition in the die outlet.

According to one or more embodiments, the extrusion temperature is in the range of 100-250° C., preferably 120-240° C., more preferably 125-220° C., even more preferably 135-200° C.

The preferred extrusion pressure depends on the embodiment of the filled polymeric layer, particularly on the type of the at least one polymer P2 and on the amount of the at least one solid particulate filler F in the first starting composition. The term “extrusion pressure” refers to the pressure of the composition at the end of the metering zone just before the composition enters the die inlet.

According to one or more embodiments, the extrusion pressure is in the range of 20-350 bar, preferably 30-240 bar, more preferably 35-200 bar, even more preferably 40-130 bar.

Furthermore, in case the first melt-processed composition comprises a blowing gas, the extruder is preferably operated with closed venting unit(s). It is essential that at least a significant part of the blowing gases released inside the extruder barrel are kept trapped in the first molten polymer composition and not released before it exits the extruder die.

In case the functional layer is a filled polymeric layer, the sealing devices that are bonded to each other in step II) of the method are preferably obtained by co-extruding the first melt-processed composition comprising the constituents of the filled polymeric layer and a second melt-processed composition comprising the constituents of the carrier layer through an extruder die.

The extrusion of the first and second melt-processed compositions may be conducted using an extrusion apparatus comprising two extruders and a common die.

Such extrusion apparatuses are well known to a person skilled in the art. A suitable extruder comprises a barrel and a screw unit contained in the barrel or a ram. Any conventional extruders, for example, a ram extruder, single screw extruder, or a twin-screw extruder may be used. Preferably, the extruder is a screw extruder, more preferably a twin-screw extruder. The screw unit of a conventional screw extruder is typically considered to comprise feed, transition, and metering sections. In the feed section the thermoplastic composition enters the channels of the rotating screw and is conveyed towards the transition section, in which the composition is compressed and melted. The composition should be fully melted when it leaves the transition section. The function of the metering section is to homogenize the melted composition and to allow it to be metered or pumped out at constant rate. The extrusion apparatus further comprises a die, preferably a flat die, consisting of manifold, approach, and lip regions. In case of a co-extrusion process, the extrusion apparatus preferably comprises at least two extruders, preferably twin-screw extruders, and a single-or a multi-manifold die.

According to one or more further embodiments, the functional layer comprises or is a layer of a pressure sensitive adhesive (PSA).

The term “pressure sensitive adhesive” refers in the present disclosure to viscoelastic materials, which adhere immediately to almost any kind of substrates by application of light pressure, and which are permanently tacky.

Suitable pressure sensitive adhesives for use in the contact layer include adhesives based on styrene block copolymers, amorphous polyolefins (APO), amorphous poly-alpha-olefins (APAO), vinyl ether polymers, and elastomers such as, for example, styrene-butadiene rubber (SBR), ethylene propylene diene monomer (EPDM) rubber, butyl rubber, polyisoprene, polybutadiene, natural rubber, polychloroprene rubber, ethylene-propylene rubber (EPR), nitrile rubber, acrylic rubber, ethylene vinyl acetate (EVA) rubber, and silicone rubber.

In addition to the above-mentioned polymers, suitable pressure sensitive adhesives typically comprise one or more additional components including, for example, tackifying resins, waxes, and additives, for example, UV-light absorption agents, UV-and heat stabilizers, optical brighteners, pigments, dyes, and desiccants.

The term “tackifying resin” designates in the present disclosure resins that in general enhance the adhesion and/or tackiness of an adhesive composition. The term “tackiness” designates in the present disclosure the property of a substance of being sticky or adhesive by simple contact. The tackiness can be measured, for example, as a loop tack. Preferred tackifying resins are tackifying at a temperature of 25° C. Examples of suitable tackifying resins include natural resins, synthetic resins and chemically modified natural resins.

Examples of suitable natural resins and chemically modified natural resins include rosins, rosin esters, phenolic modified rosin esters, and terpene resins. The term “rosin” is to be understood to include gum rosin, wood rosin, tall oil rosin, distilled rosin, and modified rosins, for example dimerized, hydrogenated, maleated and/or polymerized versions of any of these rosins.

Suitable terpene resins include copolymers and terpolymers of natural terpenes, such as styrene/terpene and alpha methyl styrene/terpene resins; polyterpene resins generally resulting from the polymerization of terpene hydrocarbons, such as the bicyclic monoterpene known as pinene, in the presence of Friedel-Crafts catalysts at moderately low temperatures; hydrogenated polyterpene resins; and phenolic modified terpene resins including hydrogenated derivatives thereof.

The term “synthetic resin” refers to compounds obtained from the controlled chemical reactions such as polyaddition or polycondensation between well-defined reactants that do not themselves have the characteristic of resins.

Monomers that may be polymerized to synthesize the synthetic resins may include aliphatic monomer, cycloaliphatic monomer, aromatic monomer, or mixtures thereof.

Aliphatic monomers can include C₄, C₅, and C₆ paraffins, olefins, and conjugated diolefins. Examples of aliphatic monomer or cycloaliphatic monomer include butadiene, isobutylene, 1,3-pentadiene, 1,4-pentadiene, cyclopentane, 1-pentene, 2-pentene, 2-methyl-1-pentene, 2-methyl-2-butene, 2-methyl-2-pentene, isoprene, cyclohexane, 1-3-hexadiene, 1-4-hexadiene, cyclopentadiene, dicyclopentadiene, and terpenes. Aromatic monomer can include C₈, C₉, and C₁₀ aromatic monomer. Examples of aromatic monomer include styrene, indene, derivatives of styrene, derivatives of indene, coumarone and combinations thereof.

Particularly suitable synthetic resins include synthetic hydrocarbon resins made by polymerizing mixtures of unsaturated monomers that are obtained as by-products of cracking of natural gas liquids, gas oil, or petroleum naphthas. Synthetic hydrocarbon resins obtained from petroleum-based feedstocks are referred in the present disclosure as “hydrocarbon resins” or “petroleum hydrocarbon resins”. These include also pure monomer aromatic resins, which are made by polymerizing aromatic monomer feedstocks that have been purified to eliminate color causing contaminants and to precisely control the composition of the product. Hydrocarbon resins typically have a relatively low average molecular weight (Mn), such in the range of 250-5000 g/mol and a glass transition temperature, determined by dynamical mechanical analysis (DMA) as the peak of the measured loss modulus (G″) curve using an applied frequency of 1 Hz and a strain level of 0.1%, of above 0° C., preferably equal to or higher than 15° C., more preferably equal to or higher than 30° C.

Examples of suitable hydrocarbon resins include C5 aliphatic hydrocarbon resins, mixed C5/C9 aliphatic/aromatic hydrocarbon resins, aromatic modified C5 aliphatic hydrocarbon resins, cycloaliphatic hydrocarbon resins, mixed C5 aliphatic/cycloaliphatic hydrocarbon resins, mixed C9 aromatic/cycloaliphatic hydrocarbon resins, mixed C5 aliphatic/cycloaliphatic/C9 aromatic hydrocarbon resins, aromatic modified cycloaliphatic hydrocarbon resins, C9 aromatic hydrocarbon resins, polyterpene resins, and copolymers and terpolymers of natural terpenes as well hydrogenated versions of the aforementioned hydrocarbon resins. The notations “C5” and “C9” indicate that the monomers from which the resins are made are predominantly hydrocarbons having 4-6 and 8-10 carbon atoms, respectively. The term “hydrogenated” includes fully, substantially and at least partially hydrogenated resins. Partially hydrogenated resins may have a hydrogenation level, for example, of 50%, 70%, or 90%.

Suitable hydrocarbon resins are commercially available, for example, under the trade name of Wingtack® series, Wingtack® Plus, Wingtack® Extra, and Wingtack® STS (all from Cray Valley); under the trade name of Escorez® 1000 series, Escorez® 2000 series, and Escorez® 5000 series (all from Exxon Mobile Chemical); under the trade name of Novares® T series, Novares® TT series, Novares® TD series, Novares® TL series, Novares® TN series, Novares® TK series, and Novares® TV series (all from RUTGERS Novares GmbH); and under the trade name of Kristalex®, Plastolyn®, Piccotex®, Piccolastic® and Endex® (all from Eastman Chemicals).

Preferably, the waterbar obtained by using the method of the present invention fulfils the general requirements for waterbars used for sealing of expansion, contraction, or construction joints in concrete structures, particularly the requirements as defined in the following standards:
DIN 18541 parts 1 and 2; BS 903 and BS 2571; CRD-C 572-74, ASTM D 412-75, and ASTM D 638; and DIN 18195:2017-07, DIN 18197:2018-01, and DIN 7865:2015-02.

Another aspect of the present invention is a method for sealing an internal joint between two sections of concrete, the method comprising steps of providing a waterbar by using the method for producing a waterbar according to the present invention and casting a first and a second section of concrete such that:
A first side portion of the waterbar becomes embedded in the first section of concrete,
A second side portion of the waterbar becomes embedded in the second section of concrete, and
A center portion of the waterbar is positioned in the joint formed between the first and second casted concrete sections.

The first and second sections of concrete can form a part of any structural or civil engineering structure, which is to be sealed against moisture and water, such as a an above-ground or underground structure, for example a building, garage, tunnel, landfill, water retention, pond, or dike.

The details of the method depend on the type of the joint to be sealed, particularly if the joint to be sealed is an expansion, a contraction or a construction joint. According to one on or more embodiments, the method for sealing an internal joint between two sections of concrete comprises steps of:
i) Positioning the waterbar such that the center portion of waterbar is positioned between upper and lower parts of a split formwork,
ii) Optionally securing the first side portion of the waterbar to one or more reinforcing steel bars,
iii) Casting the first section of concrete such that the first side portion of the waterbar becomes embedded in concrete, and
iv) Casting a second section of concrete such that the second side portion of the waterbar becomes embedded in concrete.

Another subject of the present invention is a method for sealing an external joint between two sections of concrete, the method comprising steps of:
I) Providing a waterbar obtained by using the method for producing a waterbar of the present invention,
II) Positioning the waterbar to a base onto which concrete is to be cast,
III) Casting a first and a second section of concrete such that:
A center portion of the waterbar is located in or along the joint formed between the casted sections of concrete,
A top surface of a first side portion of the waterbar forms a bond to the surface of the first section of concrete, and
A top surface of the second side portion of the waterbar forms a bond to the surface of the second section of concrete.

Another aspect of the present invention is a sealed construction comprising two sections of concrete, a gap between the sections of concrete, and a waterbar obtained by using the method for producing a waterbar according to the present invention located at the joint, the first side portion of the waterbar being bonded to the first section of concrete, the center portion of the profile being located in the gap or along the gap, and the second side portion of the waterbar being bonded to the second section of concrete.

According to one or more embodiments, the first side portion of the waterbar is embedded in the first section of concrete and the second side portion of the waterbar is embedded in the second section of concrete, wherein the center portion of the profile is located in a gap.

According to one or more further embodiment, the center portion of the waterbar is located in or along the joint formed between the sections of concrete, a top surface of a first side portion of the waterbar is bonded to the surface of the first section of concrete, and a top surface of the second side portion of the waterbar is bonded to the surface of the second section of concrete.

According to one or more embodiments, the sealed construction has been obtained by using the method for sealing an internal joint between two sections of concrete of the present invention or by using the method for sealing an external joint between two sections of concrete of the present invention.

### EXAMPLES

### Preparation of Waterbars

The inventive waterbar materials were produced by thermally laminating two SikaProof A+ waterproofing membranes (available from Sika Schweiz AG) to each other.

A single-layer Sika Waterbar FB-125 (available from Sika Schweiz AG) was used as a reference waterbar material.

### Preparation of the Concrete Test Specimen

Two sample strips having dimensions of 200 mm (length)×50 mm (width) were cut from the waterbar materials obtained as described above. The sample strips were placed into formworks having a dimension of 200 mm (length)×50 mm (width)×30 mm (height).

One edge of each sample strip was covered with an adhesive tape having a length of 50 mm and width coinciding with the width of the strip to prevent the adhesion to the hardened concrete. The adhesive tapes were used to provide easier installation of the test specimens to the peel resistance testing apparatus.

For the preparation of concrete specimens, a batch of fresh concrete formulation was prepared. The fresh concrete formulation was obtained by mixing 8.9900 kg of a concrete dry batch of type MC 0.45 conforming to EN 1766 standard, 0.7440 kg of water and 0.0110 kg of Viscocrete 3082 for five minutes in a tumbling mixer. The concrete dry batch of type MC 0.45 contained 1.6811 kg of CEM I 42.5 N cement (Normo 4, Holcim), 7.3089 kg of aggregates containing 3% Nekafill-15 (from KFN) concrete additive (limestone filler), 24% sand having a particle size of 0-1 mm, 36% sand having a particle size of 1-4 mm, and 37% gravel having a particle size of 4-8 mm. Before blending with water and Viscocrete 3082 the concrete dry batch was homogenized for five minutes in a tumbling mixer.

The formworks containing the sample strips were subsequently filled with the fresh concrete formulation and vibrated for two minutes to release the entrapped air. After hardening for 24 hours under standard atmosphere (air temperature 23° C., relative air humidity 50%), the test concrete specimens were stripped from the formworks and measured for concrete peel resistances.

### Concrete Peel Resistances

The measurement of peel resistances was conducted in accordance with the procedure laid out in the standard DIN EN 1372:2015-06. A Zwick Roell AllroundLine Z010 material testing apparatus equipped with a Zwick Roell 90°-peeling device (type number 316237) was used for conducting the peel resistance measurements.

In the peel resistance measurements, a concrete specimen was clamped with the upper grip of the material testing apparatus for a length of 10 mm at the end of the concrete specimen comprising the taped section of the sample strip. Following, the strip was peeled off from the surface of the concrete specimen at a peeling angle of 90° and at a constant cross beam speed of 100 mm/min. During the measurements the distance of the rolls was approximately 570 mm. The peeling of the sample strip was continued until a length of approximately 140 mm of the strip was peeled off from the surface of the concrete specimen. The values for peel resistance were calculated as average peel force per width of the sample strip [N/50 mm] during peeling over a length of approximately 70 mm thus excluding the first and last quarter of the total peeling length from the calculation.

The average peel resistance values presented in Table 2 have been calculated as an average of two measurements conducted with the same sample strip.

### Tensile Strength and Elongation at Break

Tensile strength and elongation at break (MD, CD) were measured according to EN 12311-2 standard using method A or B at normal room temperature using a Zwick tensile tester and a cross head speed of 100 mm/min.

TABLE 2

| Mechanical properties | Ref-1 | Ex-1 |
|---|---|---|
| Bonding to concrete 36 h, RT [N/cm] | 73 | 44 |
| Bonding to concrete 7 d, RT [N/cm] | 80 | 126 |
| Tensile strength MD, Method A | 305 | 330 |
| [N/cm] | | |
| Tensile strength CD, Method A | 403 | 339 |
| [N/cm] | | |
| Tensile strength MD, Method B | 4 | 9 |
| [N/cm] | | |
| Elongation MD, Method A [%] | 11 | 16 |
| Elongation CD [%], Method A | 302 | 125 |
| Elongation MD, Method B [%] | 405 | 783 |

MD = machine direction,
CD = cross machine direction

1. A method for producing a waterbar comprising steps of:
I) providing first and second sealing elements each comprising a carrier layer comprising at least one polymer P1 and having upper and lower major surfaces and a functional layer covering at least a portion of the upper major surface of the carrier layer and
II) bonding the first and second sealing element to each other such that their carrier layers become directly or indirectly connected to each other over at least parts of their opposing lower major surfaces,
wherein the functional layer of the first and second sealing elements is operative to bond with a fresh cementitious composition casted against it and allowed to harden.

2. The method according to claim 1, wherein step II) is conducted by thermally or adhesively laminating the lower major surface of the carrier layer of the first sealing element to at least a portion of the lower major surface of the carrier layer of the second sealing element.

3. The method according to claim 1, wherein at least one of the first and second sealing elements further comprises a reinforcement layer fully embedded into the carrier layer or located between the carrier layer and the functional layer.

4. The method according to claim 1 comprising a further step of providing a reinforcing laver, wherein step II) of the method is conducted in such a manner that the reinforcing layer becomes sandwiched between the carrier layers of the first and second sealing elements.

5. The method according to claim 1, wherein the carrier layer comprises at least 35 wt.-% of the at least one polymer P1.

6. The method according to claim 1, wherein the functional layer is selected from a layer of fiber material, a filled polymeric layer, a bitumen-based layer, and a layer of pressure sensitive adhesive.

7. The method according to claim 1, wherein the functional layer is a filled polymeric layer comprising:
a) 25-75 wt.-% of at least one polymer P2 and
b) 15-65 wt.-% of a least one solid particulate filler F.

8. The method according to claim 7, wherein the at least one polymer P2 is selected from ethylene vinyl acetate copolymers, polyolefins, halogenated polyolefins, polyvinylchloride, rubbers, and ketone ethylene esters.

9. The method according to claim 7, wherein the at least one polymer P2 comprises at least one ethylene vinyl acetate copolymer P21.

10. The method according to claim 7, wherein the at least one solid particulate filler F is selected from the group consisting of inert mineral fillers, mineral binders, and synthetic organic fillers.

11. The method according to claim 6, wherein the filled polymeric layer is obtained by extruding or co-extruding a first melt-processed composition comprising the constituents of the filled polymeric layer through an extruder die.

12. The method according to claim 11, wherein the first melt-processed composition comprises a blowing gas, which is released from the first melt-processed starting composition through surface(s) of the extruded profile discharged from the extruder die.

13. The method according to claim 11, wherein first melt-processed composition is obtained by melt-processing a first starting composition comprising the constituents of the filled polymeric layer and further at least one chemical blowing agent CBA.

14. A method for sealing an internal joint between two sections of concrete, the method comprising steps of providing a waterbar by using the method according to claim 1 and casting a first and a second section of concrete such that:
a first side portion of the waterbar becomes embedded in the first section of concrete,
a second side portion of the waterbar becomes embedded in the second section of concrete, and
a center portion of the waterbar is positioned in the joint formed between the first and second casted concrete sections.

15. A method for sealing an external joint between two sections of concrete, the method comprising steps of:
I) providing a waterbar by using the method according to claim 1,
II) positioning the waterbar to a base onto which concrete is to be cast,
III) casting a first and a second section of concrete such that:
a center portion of the waterbar is located in or along the joint formed between the casted sections of concrete,
a top surface of a first side portion of the waterbar forms a bond to the surface of the first section of concrete, and
a top surface of the second side portion of the waterbar forms a bond to the surface of the second section of concrete.
